(19) United States
(12) Patent Application Publication
(10) Pub. No.: US 2018/0093627 A1
(43) Pub. Date: Apr. 5, 2018

(54) RETRACTABLE AUTOMOBILE SIDE GUARD APPARATUS

(71) Applicant: Jose Arnaldo Febus, Paulsboro, NJ (US)

(72) Inventor: Jose Arnaldo Febus, Paulsboro, NJ (US)

(21) Appl. No.: 15/283,312

(22) Filed: Oct. 1, 2016

(51) Int. Cl. B60R 19/38; B60R 19/14; B60R 19/42

(52) U.S. Cl. CPC B60R 19/38; B60R 19/42; B60R 19/14

(57) ABSTRACT

A retractable automobile side guard apparatus includes a mountable base for attaching the apparatus to an automobile frame, the mountable base slidably coupled to a base extension, a hinge coupled to the base extension and to a vertical base, the vertical base slidably coupled to a vertical extension, a horizontal base coupled to the vertical extension, and a pair of horizontal extensions slidably coupled to the horizontal base. The vertical and horizontal elements when deployed provide a barrier to protect the sides of a parked car against minor impacts. The apparatus can be stored in a retracted state under the car when not in use. The apparatus can be arranged to be deployed and retracted either manually or automatically.

### BACKGROUND

It is common practice for drivers to park their cars in a parking lot or garage close enough to neighboring cars so that a door of one car when swung open often touches an adjacent car, generally on, the adjacent car's door or body. If the door is swung open with more than a controlled gentle force, it can hit the adjacent car with enough force to scratch or dent the door or body panel of, the adjacent car.

This problem has existed practically since driving and parking cars first became prevalent. The prior art includes many devices and arrangements designed to enhance or improve on standard automobile body protection features, including some to reduce or eliminate the mishaps in, parking lots described above. None have proven to be entirely satisfactory, however. Accordingly, a better way to protect one's car against dents and scratches when it is parked is still desirable.

### SUMMARY

A retractable automobile side guard apparatus includes a mountable base for attaching the apparatus to an automobile frame, the mountable base slidably coupled to a base extension, a hinge coupled to the base extension and to a vertical base, the vertical base slidably coupled to a vertical extension, a horizontal base coupled to the vertical extension, and a pair of horizontal extensions slidably coupled to the horizontal base. The vertical and horizontal elements when deployed provide a barrier to protect the sides of a parked car against minor impacts. The apparatus can be stored in a retracted state under the car when not in use. The apparatus can be arranged to be, deployed and retracted either manually or automatically.

The foregoing general description and the following detailed description and figures are exemplary and explanatory and are intended to provide further explanation of the invention as claimed. The scope of the invention is not defined by the descriptions, but by the appended claims.

### BRIEF DESCRIPTION OF THE DRAWING

The accompanying drawing may provide a better understanding of the invention. The drawing illustrates a certain disclosed embodiment, and serves to clarify the principles of the invention, not to limit its scope.

FIG. 1 is a perspective view of an exemplary embodiment of the disclosed automobile side guard, attached to the underside of an automobile in its deployed position.

### DETAILED DESCRIPTION

A retractable automobile side guard apparatus is disclosed that provides protection against side impacts to the car from the car bottom to the roof, and from the front bumper to the rear bumper. The figure and descriptions provided herein may have been simplified to illustrate aspects that are relevant for a clear understanding of the herein described methods and apparatus, while eliminating for the purpose of clarity other aspects that, may be found in typical methods and apparatus Those of ordinary skill in the relevant arts may recognize that other elements or steps may be desirable or necessary to implement the devices systems, and methods described herein. But because such elements and steps are well known in the art, and because they do not facilitate a better understanding of this disclosure, a discussion of such elements and steps may not be provided herein. However, the present disclosure should be understood to inherently include all such elements, variations, and modifications to the described elements and aspects that would be known to those of ordinary, skill in the relevant, arts. Thus, although specific details of certain illustrative embodiments are described, many of these details may be modified, supplemented, or eliminated.

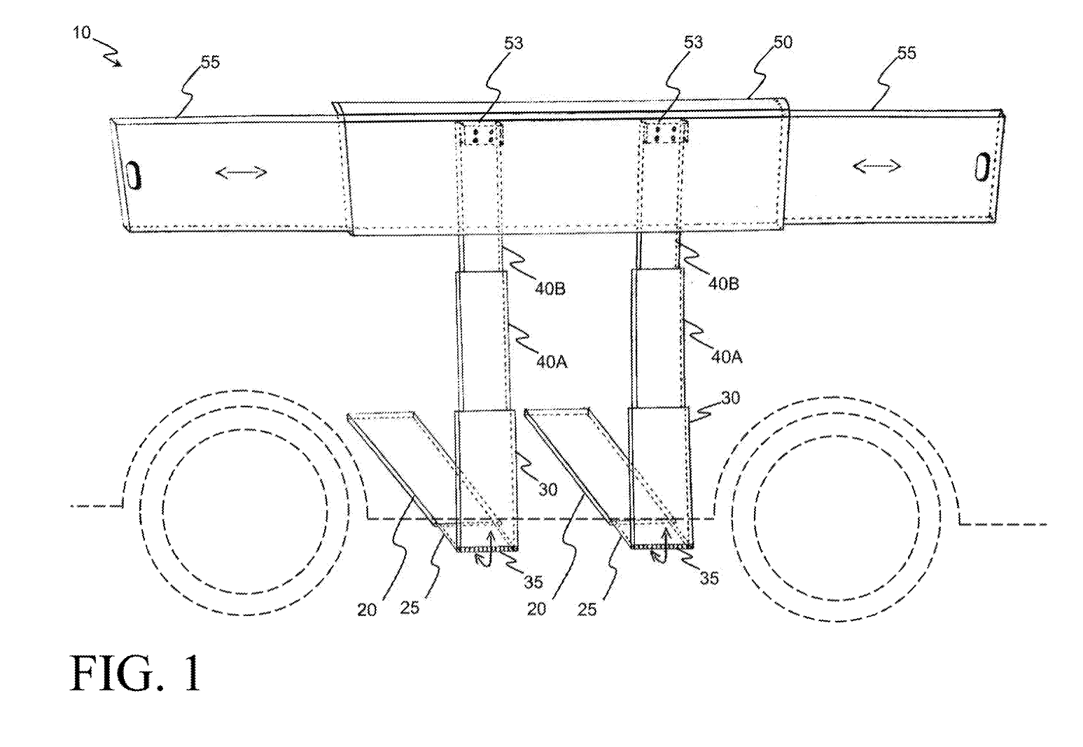

It is noted that the terms “automobile”, “vehicle” and “car” may be used interchangeably herein. Referring now in detail to FIG. 1, an illustrative embodiment of the disclosed automobile side guard is shown. FIG. 1 displays in phantom two wheels and the lower portion of a side of an automobile, in combination with a side guard assembly 10. The assembly as illustrated has two base elements 20 fixedly coupled to the underside of the automobile in any convenient manner. For example, the base elements may be permanently welded or removably clamped or bolted, or otherwise fixedly attached to the frame of the vehicle (not shown). Although two base elements are shown, more or fewer may be used, depending for example on the configuration of the vehicle.

A sliding base element 25 may be slidably coupled to each base element 20. The sliding element 25 may be extended when the side guard is deployed, and retracted when the side guard is not in use. The base and slidable base elements may be slidingly configured and arranged in any convenient manner, for example the base element 20 may be hollow and the telescoping element 25 arranged to slide into and out of the base element. Or, base element 20 may have a channel configuration, and the sliding element 25 may slide within the channel. Other configurations may alternatively be used.

A vertical base element 30 may be pivotably coupled to each sliding base element 25, for example, with a hinge 35. In a currently preferred embodiment, the vertical base element 30 and hinge 35 may have substantially similar cross sectional profiles as the slidable base element 25. Vertical base element 30 may then be moved into a position parallel with the slidable base element, and elements 25, 30, and 35 may be retracted together into base element 20. One or more sliding vertical elements 40A, 40B, may be assembled and slidably coupled to each vertical base element 30. The sliding element(s) 40 may be extended telescopically as the side guard is deployed, and retracted into vertical base element 30 when the side guard is not in use.

A horizontal base element 50 may be fixedly coupled to the top portion of sliding vertical element(s) 40. In a currently preferred embodiment, horizontal base element 50 may be bolted or welded to vertical element 40 using set-offs 53 to provide clearance between horizontal base element 50 and vertical elements 30, 40, when the vertical elements are retracted.

One or more horizontal sliding elements 55 may be slidably coupled to horizontal base element 50. For example, horizontal sliding element(s) 55 may be extended when the side guard is deployed, and retracted when the side guard is not in use. The horizontal base 50 and horizontal slidable elements 55 may be slidingly configured and arranged in any convenient manner. For example the horizontal base element 50 may be hollow and the horizontal sliding element(s) 55 may be arranged to slide into and out of horizontal base element 50. Or, horizontal base element 50 may have a channel configuration, and the horizontal sliding elements 55 may slide within the channel. Other configurations may alternatively be used.

It is contemplated that two side guard assemblies 10 would be installed on a car one on each side of the car. One or both may be deployed as desired. In a retracted state, horizontal sliding elements 55 may be slid into horizontal base element 50. The retracted horizontal elements may then be collapsed as vertical sliding element(s) 40 are retracted into vertical base elements) 30. The retracted horizontal and vertical elements may then be pivoted so that vertical base element 30 is parallel to base element 20 and the retracted vertical elements further retracted into the base element. When side guard assembly is fully retracted, it will be substantially entirely positioned underneath the car arid adjacent to the bottom of the care to which it is attached. In this retracted position the assembly will be unobtrusive and should not be unsightly.

The opposite procedure may be used to deploy a side guard assembly from its retracted position. That is, extend the retracted vertical and horizontal base and sliding elements by sliding them horizontally from under the car, pivot them into a vertical position, extend the vertical sliding elements from the vertical base elements, and finally extend the horizontal sliding elements from the horizontal base element. When deployed, the side guard assembly can protect a parked car from the bottom of the car body to the roof, and from front bumper to rear bumper, against minor impacts from opening doors of adjacent parked cars.

Additional features may be added to the basic assembly described. For example, in an embodiment a source of power and associated control and structural elements may be provided to automatically deploy and retract the side guard assembly.

In an embodiment, locking elements may be provided to each of the movable parts to secure them in either or both of a retracted position and one or more deployed, positions. For example, a plurality of regularly spaced bracing or locking elements may be coupled to the vertical and horizontal elements so they may be extended vertically to the top of the car but no higher, and from the front to the rear of the car but no further. Thereby, the same type and size of side guard assembly can be used to protect different sized cars without resulting in any protrusions that may be unsightly or dangerous. Moreover, a side guard assembly may be removably attached to a car, for example using high holding capacity clamps with holding elements that are screwed or toggled into their holding position. The same side guard assembly may then be detached from one car and attached to another.

In an embodiment, one or more compressible elements may be attached to one or more locations on vertical elements, horizontal elements, or both. Moreover, such elements may be attached to the assembly on the side of the assembly facing the car it is attached to when deployed, or on the side facing away from the car, or both. For example, one or more rubber stops may be removably or permanently attached to those elements at locations that could impinge the attached car if the assembly is impacted forcefully, such as by a moving vehicle. This may prevent the side guard assembly from damaging the attached car if it is struck harder than would be expected from a car door. Such rubber or other compressible elements may include stops in the shape of a dome, plate, or strip. Similar elements may also or additionally be attached to the side of the assembly elements that face away from the attached car, for example, to protect the car door of an adjacent car from being harmed if it swings too hard into the side guard assembly.

Although the invention has been described and illustrated in exemplary forms with a certain degree of particularity, it is emphasized that the description and illustrations have been made by way of example only. Numerous changes in the details of construction, combination, and arrangement of parts and steps may be made without deviating from the scope of the invention. Accordingly, the invention is not limited except as by the appended claims and the elements explicitly recited therein.

What is claimed is:

1. A retractable automobile (car) side guard apparatus, comprising:
a mountable base coupled to the underside of a car;
a base extension slidably coupled to the mountable base;
a vertical base pivotably coupled to the base extension with a hinge;
a vertical extension slidably coupled to the vertical base;
a horizontal base coupled to the vertical extension; and
a pair of horizontal extensions slidably coupled to the horizontal base.

2. The apparatus of claim 1, further comprising:
a second mountable base coupled to the underside of the car;
a second base extension slidably coupled to the second mountable base;
a second vertical base pivotably coupled to the second base extension with a second hinge; and
a second vertical extension slidably coupled to the second vertical base;
wherein the horizontal base is coupled to the second slidable vertical extension.

3. The apparatus of claim 1, wherein the vertical extension comprises two sections slidably coupled together.

4. The apparatus of claim 1, wherein one of the pair of horizontal extensions is slidable toward the front of the car, and the other is slidable toward the rear of the car.

5. The apparatus of claim 1, wherein the mountable base can be mounted by welding, bolting, or clamping it to the frame of the car.

6. The apparatus of claim 1, further comprising an set-off block coupled to the vertical extension and to the horizontal base.

7. The apparatus of claim 1, further comprising a compressible bumper coupled to at least one of the vertical extension and the horizontal base facing the car.

8. The apparatus of claim 1, further comprising a compressible bumper coupled to at least one of the vertical base, the vertical extension, and the horizontal base, facing away from the car.

9. The apparatus of claim 1 further comprising at least one brace coupled to the base extension and the vertical base when the apparatus deployed, to lock the base extension to the vertical base at a predetermined angle.

10. The apparatus of claim 1, further comprising at least one fastener to fasten at least one of the extensions in a predetermined position in elation to the responding base.

11. The apparatus of claim 1, further comprising:
an apparatus controller;
a power source operatively coupled to the apparatus controller; and
a linkage operatively coupled to the power source and to at least one of the base extension, the vertical extension, and the horizontal extensions for extending and retracting the extension(s).

12. A method of deploying a retractable automobile (car) side guard apparatus that includes a mountable base affixed to a car frame, a base extension slidably coupled to the mountable base, a hinge coupled to the base extension and to a vertical base, a vertical extension slidably coupled to the vertical base, a horizontal base coupled to the vertical extension, and a pair of horizontal extensions slidably coupled to the horizontal base, the apparatus initially stored under the car in a retracted state, the method comprising:
applying a horizontally directed force to the apparatus to extend the base extension;
applying a rotating force to the apparatus to pivot the vertical base around the hinge;
applying a vertically directed force to the apparatus to extend the vertical extension; and
applying a horizontally directed force to extend the horizontal extension.

13. A method of retracting a retractable automobile (car) side guard apparatus that includes a mountable base affixed to a car frame, a base extension slidably coupled to the mountable base, a hinge coupled to the base extension and to a vertical base, a vertical extension slidably coupled to the vertical base, a horizontal base coupled to the vertical extension, and a pair of horizontal extensions slidably coupled to the horizontal base, the apparatus initially in a deployed state, the method comprising:
applying a horizontally directed force to retract the horizontal extension;
applying a vertically directed force to the apparatus to retract the vertical extension; and
applying a rotating force to the apparatus to pivot the vertical base around the hinge; and
applying a horizontally directed force to the apparatus to retract the base extension.
